(19) United States
(12) Patent Application Publication
(10) Pub. No.: US 2024/0135188 A1
(43) Pub. Date: Apr. 25, 2024

(54) SEMI-SUPERVISED FRAMEWORK FOR EFFICIENT TIME-SERIES ORDINAL CLASSIFICATION

(71) Applicant: NEC Laboratories America, Inc., Princeton, NJ (US)

(72) Inventors: Liang Tong, Lawrenceville, NJ (US); Takehiko Mizoguchi, Princeton, NJ (US); Zhengzhang Chen, Princeton Junction, NJ (US); Wei Cheng, Princeton, NJ (US); Haifeng Chen, West Windsor, NJ (US); Nauman Ahad, Atlanta, GA (US)

(21) Appl. No.: 18/545,055

(22) Filed: Dec. 19, 2023

Related U.S. Application Data
(63) Continuation of application No. 18/152,238, filed on Jan. 10, 2023.
(60) Provisional application No. 63/308,196, filed on Feb. 9, 2022.

(51) Int. Cl. G06N 3/0895; G06N 3/0442

(52) U.S. Cl. CPC G06N 3/0895; G06N 3/0442

(57) ABSTRACT

A computer-implemented method for ordinal prediction is provided. The method includes encoding time series data with a temporal encoder to obtain latent space representations. The method includes optimizing the temporal encoder using semi-supervised learning to distinguish different classes in the labeled space using labeled data, and augment the latent space representations using unlabeled training data, to obtain semi-supervised representations. The method further includes discarding a linear layer after the temporal encoder and fixing the temporal encoder. The method also includes training k-1 binary classifiers on top of the semi-supervised representations to obtain k-1 binary predictions. The method additionally includes identifying and correcting inconsistent ones of the k-1 binary predictions by matching the inconsistent ones to consistent ones of the k-1 binary predictions. The method further includes aggregating the k-1 binary predictions to obtain an ordinal prediction.

### RELATED APPLICATION INFORMATION

This application is a continuing application of U.S. patent application Ser. No. 18/152,238, filed Jan. 10, 2023 which claims the benefit of U.S. Provisional Patent Application No. 63/308,196, filed on Feb. 9, 2022, both of which are incorporated herein by reference in their entirety.

### BACKGROUND

### Technical Field

The present invention relates to classifiers and more particularly to a semi-supervised framework for efficient time-series ordinal classification.

### Description of the Related Art

Real-world classification problems often involve labels that have an inherent order. Consider an example where a patient's health status is being classified into three label categories: good; stable; and critical. As stable is closer to critical, it would be catastrophic if critical is miss-classified as good. In such a setting, nominal classification methods, such as a classifier employing cross-entropy loss with one-hot encoded labels, would be susceptible to making such errors. This undesirable behavior is a result of the loss function that equally penalizes miss-classifications. In contrast, ordinal classification methods, sometimes referred to as ordinal regression, discourage errors that violate the inherent order in labels. Therefore, ordinal classification methods are more suitable for classification problems that involve ordered labels. We can consider ordinal classification to lie between nominal classification and regression. Unlike regression tasks that map input onto a continuous and ordered space, ordinal classification requires inputs to be classified into discrete categories that are ordered.

Traditional ordinal classification methods have two weaknesses which make them impractical in real operations: First, they assume that all the training data is labeled, which is not always true, especially when asking human expert for annotation is costly and time-consuming. Second, the predictions of the collection of binary classifiers can be contradictory. In above running example, the first binary classifier can indicate that a patient's health is critical, but the second shows good, making aggregating of the two classification difficult.

### SUMMARY

According to aspects of the present invention, a computer-implemented method for ordinal prediction is provided. The method includes encoding time series data with a temporal encoder to obtain latent space representations. The method includes optimizing the temporal encoder using semi-supervised learning to distinguish different classes in the labeled space using labeled data, and augment the latent space representations using unlabeled training data, to obtain semi-supervised representations. The method further includes discarding a linear layer after the temporal encoder and fixing the temporal encoder. The method also includes training k-1 binary classifiers on top of the semi-supervised representations to obtain k-1 binary predictions. The method additionally includes identifying and correcting inconsistent ones of the k-1 binary predictions by matching the inconsistent ones to consistent ones of the k-1 binary predictions. The method further includes aggregating the k-1 binary predictions to obtain an ordinal prediction.

According to other aspects of the present invention, a computer program product for ordinal prediction is provided. The computer program product includes a non-transitory computer readable storage medium having program instructions embodied therewith. The program instructions are executable by a computer to cause the computer to perform a method. The method includes encoding, by a hardware processor of the computer, time series data with a temporal encoder to obtain latent space representations. The method further includes optimizing, by the hardware processor, the temporal encoder using semi-supervised learning to distinguish different classes in the labeled space using labeled data, and augment the latent space representations using unlabeled training data, to obtain semi-supervised representations. The method also includes discarding, by the hardware processor, a linear layer after the temporal encoder and fixing the temporal encoder. The method additionally includes training, by the hardware processor, k-1 binary classifiers on top of the semi-supervised representations to obtain k-1 binary predictions. The method further includes identifying and correcting, by the hardware processor, inconsistent ones of the k-1 binary predictions by matching the inconsistent ones to consistent ones of the k-1 binary predictions. The method also includes aggregating, by the hardware processor, the k-1 binary predictions to obtain an ordinal prediction.

According to still other aspects of the present invention, a computer processing system for ordinal prediction is provided. The system includes a memory device for storing program code. The system further includes a processor device, operatively coupled to the memory device, for running the program code to encode time series data with a temporal encoder to obtain latent space representations. The processor device also runs the program code to optimize the temporal encoder using semi-supervised learning to distinguish different classes in the labeled space using labeled data, and augment the latent space representations using unlabeled training data, to obtain semi-supervised representations. The processor device additionally runs the program code to discard a linear layer after the temporal encoder and fix the temporal encoder. The processor device further runs the program code to train k-1 binary classifiers on top of the semi-supervised representations to obtain k-1 binary predictions. The processor device also runs the program code to identify and correct inconsistent ones of the k-1 binary predictions by matching the inconsistent ones to consistent ones of the k-1 binary predictions. The processor additionally runs the program code to aggregate the k-1 binary predictions to obtain an ordinal prediction.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a block diagram showing exemplary semi-supervised k-class ordinal learning, in accordance with an embodiment of the present invention;

FIG. 3 shows an exemplary method for semi-supervised k-class ordinal learning, in accordance with an embodiment of the present invention;

FIG. 4 is a block diagram showing an exemplary processing flow with alternatives, in accordance with an embodiment of the present invention;

FIG. 5-6 are flow diagrams showing another exemplary method for ordinal classification, in accordance with an embodiment of the present invention; and

FIG. 7 is a block diagram showing an exemplary environment to which the present invention can be applied, in accordance with an embodiment of the present invention.

### DETAILED DESCRIPTION OF PREFERRED EMBODIMENTS

Embodiments of the present invention are directed to a semi-supervised framework for efficient time-series ordinal classification.

As mentioned above, many state-of-the-art techniques ideally assume all training data is labeled thus can perform poorly when only a small portion of training data is annotated. Moreover, inconsistent results from the collection of binary classifiers can also contribute to unsatisfactory performance.

One or more embodiments provide a semi-supervised representation learning module. The semi-supervised representation learning module aims to learn a good representation by training on both labeled and unlabeled data such that it can achieve high data efficiency. In one or more embodiments, the semi-supervised representation learning module uses a semi-supervised loss which allows to learn a representation from labeled data, and the representation can be augmented by unlabeled data as well.

One or more embodiments provide an ensembled binary classification module. The ensembled binary classification module decomposes the semi-supervised ordinal k-class learning problem into k-1 binary learning problems. The ensembled binary classification module works on top of the representation module and returns a collection of binary prediction results. In one or more embodiments, the ensembled binary classification model transforms ordinal classification, a complex problem into controller binary classification sub-problems.

One or more embodiments provide a robust aggregation module. The robust aggregation module aims to detect and correct inconsistent prediction results among the collection of binary classifiers, then aggregate the results into the final judgment. In one or more embodiments, the robust aggregation module employs an inconsistency detector to identify and correct contradictions among binary classifications. The aggregation further enforces that ordinal information can be preserved in the final output.

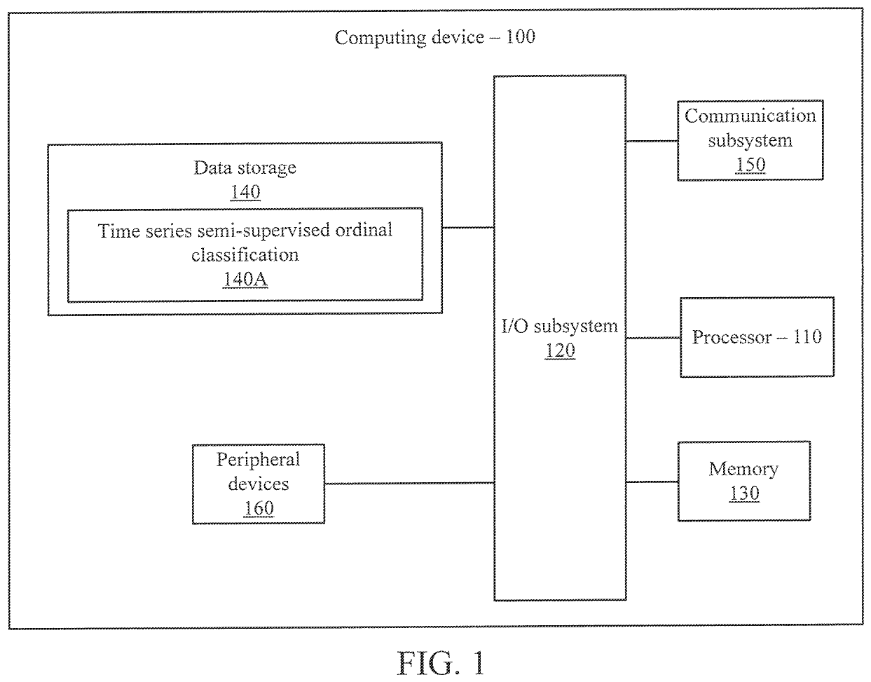

FIG. 1 is a block diagram showing an exemplary computing device 100, in accordance with an embodiment of the present invention. The computing device 100 is configured to perform time-series semi-supervised ordinal classification.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for time-series semi-supervised ordinal classification. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

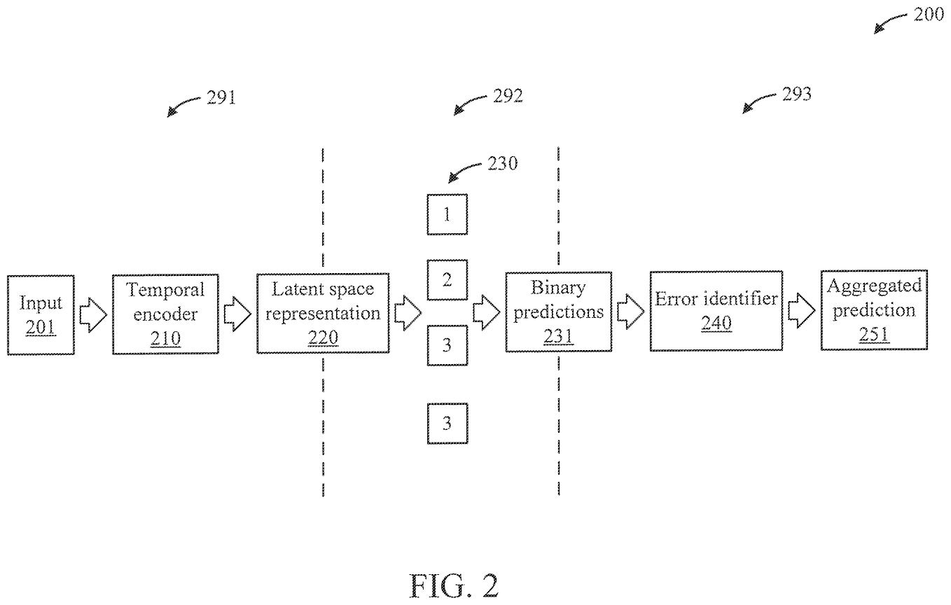

FIG. 2 is a block diagram showing exemplary semi-supervised k-class ordinal learning 200, in accordance with an embodiment of the present invention.

The semi-supervised k-class ordinal learning 200 involves a first phase 291 corresponding to semi-supervised learning, a second phase 292 corresponding to binary classification on the semi-supervised representations, and a third phase 293 corresponding to robust aggregation.

Given a collection of labeled and unlabeled data 201, a temporal encoder (normally, an LSTM neural network) 210 is trained by semi-supervised learning 291. By doing so, the original input 201 can be transformed into a latent space representation 220. The present invention makes use of the latent space representation 220 and builds k-1 binary classifiers 230 on top of that. Afterward, the present invention uses an error identifier 240 to check if there is any inconsistency among the binary predictions 231, and correct when such inconsistency is identified. Finally, the present invention aggregates the corrected binary predictions 231 as the ordinal prediction 251.

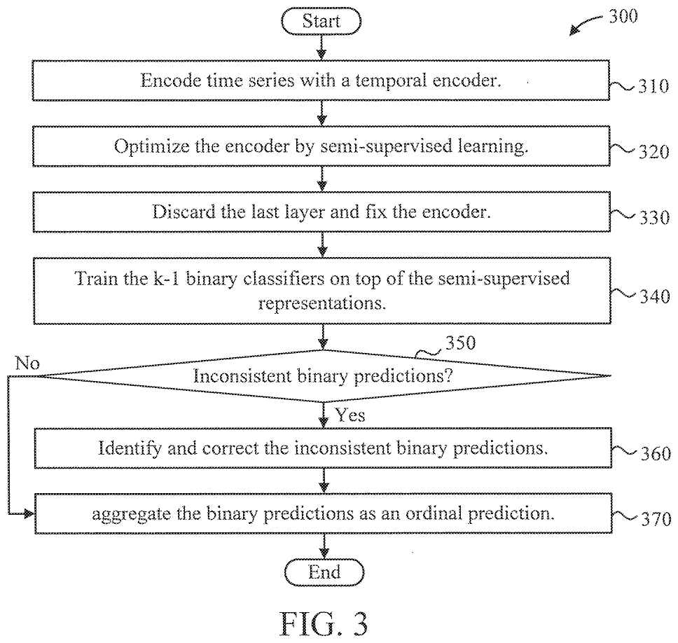

FIG. 3 shows an exemplary method 300 for semi-supervised k-class ordinal learning, in accordance with an embodiment of the present invention.

At block 310, encode time series with a temporal encoder.

At block 320, optimize the encoder by semi-supervised learning.

At block 330, discard the last layer and fix the encoder.

At block 340, train the k-1 binary classifiers on top of the semi-supervised representations.

At block 350, determine if the binary classifiers are providing inconsistent binary predictions. If so, then proceed to block 260. Otherwise, proceed to block 270.

At block 360, identify and correct the inconsistent binary predictions.

At block 370, aggregate the binary predictions as an ordinal prediction.

A further description will now be given regarding block 310, in accordance with an embodiment of the present invention.

We first use neural networks to transform time series segments from high dimensional to low dimensional latent space. These segments are sliced from a very long sequenced in the training data. The sequence is all the record value in a continuous time period. To capture the temporal dependency in the time series, we use an LSTM 210 as the encoder to transform the time series into latent space representations by optimizing the LSTM 210 with some loss functions, which are described below. Note that other encoders, such as GRU can be used as well, while maintaining the spirit of the present invention.

A further description will now be given regarding block 320, in accordance with an embodiment of the present invention.

Our goal is to use the encoder in block 310 to obtain representations such that: (a) Input data belonging to different classes can be well distinguished in the latent space (we use the labeled data to achieve this); and (b) the learned representations can be further augmented by unlabeled data in the training set.

To achieve these objectives, semi-supervised learning is used to learn these representations as follows:

$$ℒ ( θ ) = {\sum }_{( X , Y ) ∈ {X}_{L}} {ℒ}_{Nominal} ( X , Y ) + {\sum }_{X ∈ {X}_{U}} {ℒ}_{self} ( X )$$

where X_{L} is the collection of labeled data, X_{U} is the unlabeled training data, and θ is the parameters of the encoder that needs to be optimized. Here, two loss functions are combined to enable semi-supervised learning: Lₙₒₘᵢₙₐₗ for labeled data; and L_{self} if for unlabeled data.

For labeled data, cross-entropy loss is used to learn the representation. Specifically, a linear layer is added after the LSTM 210 such that the linear layer is a classifier on the latent space representation. Here, both the LSTM 210 and the linear layer are trainable. Then, for each data X and its label Y, the training loss is as follows:

$${ℒ}_{Nominal} ( X , Y = c ) = - log \frac{exp {f}_{θ}^{c} ( x )}{{\sum }_{k = 1}^{K} exp {f}_{θ}^{k} ( x )}$$

where the superscript k in ƒ_{θ}^{k} represents the k-th logit of the final linear layer.

For unlabeled data, self-supervised learning is used to augment the representation that is learned from labeled data. Specifically, the N-pair contrastive loss is used for self-supervision as follows:

$${ℒ}_{self} ( x ) = - log \frac{exp ( \frac{{f}_{θ}^{t} ( x ) {f}_{θ} ( {x}^{+} )}{τ} )}{exp ( {{f}_{θ} ( x )}^{t} {f}_{θ} ( \frac{{x )}^{+}}{τ} ) + {\sum }_{i = 1}^{L - 1} exp ( {f}_{θ} ( \frac{{x )}^{t} {f}_{θ} ( {x}^{-} )}{τ} )}$$

where r is a temperature scaling constant. For a given input x, this loss function requires similar samples to x denoted by x⁺and a dissimilar sample x⁻. Here, x⁺is obtained by data augmentation such as inverting the time series, time warping, and scaling on x such that x and x⁺are still similar. On the other hand, when the neural network is trained in a batch manner (the most common way to use training data), x⁻is randomly selected from all the rest of the data in the same batch besides x.

Once the nominal loss and self-supervision loss are identified, the neural network is optimized by finding the optimal θ that minimized training loss L(θ).

A further description will now be given regarding block 330, in accordance with an embodiment of the present invention.

Once the LSTM 210 and the linear layer after it are trained, the linear layer is removed, and the encoder is fixed. From now on, given an input time series data, the final hidden state of the LSTM 210 is the semi-supervised latent space representation, which is the input feature vector that is used to train the K-1 binary classifiers 230.

A further description will now be given regarding block 340, in accordance with an embodiment of the present invention.

Once the representation learning encoder network is trained, the latent space representations 220 are used as feature vectors to train K-1 binary classifiers 230, where K is the number of classes. This can be achieved by using the following steps.

First, for the k-th binary classifier 230, we re-label each of the data that is previously labeled in the training set. Specifically, let (xᵢ, yᵢ) be the i-th data and corresponding label of the labeled training data, we make a copy of the training data by making xᵢ^{k}=xᵢ and re-labeling yᵢ is as follows:

$${y}_{i}^{k} = \{ \begin{matrix}0 , & if {y}_{i} \leq k \\ 1 , & otherwise\end{matrix}$$

By doing so, the training data {xᵢ^{k}, yᵢ^{k}}ᵢ₌₁^{N} is used to train the k-th binary classifier which indicates that whether the predicted label is greater than k.

Second, once the training data corresponding to each binary classifier is re-labeled, we train the K-1 classifiers 230 using a nominal loss. Specifically, let h_{ϕ}_{ₖ} denote the k-th binary classifier 230 parametrized by ϕₖ. Then, h_{ϕ}_{ₖ} is trained by minimizing the following loss function:

L(ϕₖ)=Σᵢ₌₁^{N}L_{Nominal}(h_{ϕ}_{ₖ}(ƒ_{θ}(xᵢ^{k})), yᵢ^{k})

where L_{Nominal} can be any loss function that can be used to train binary classifier, such as the softmax cross-entropy loss or the binary cross-entropy loss.

A further description will now be given regarding block 350, in accordance with an embodiment of the present invention.

Once the LSTM 210 and the binary classifiers 230 are trained, for a given test data (x, y), the binary predictions {h_{ϕ}_{ₖ}(ƒ_{θ}(x))}ₖ₌₁^{K-1} are checked by an error identifier. As h_{ϕ}_{ₖ}(ƒ_{θ}(x)) returns a binary result, and the k-th binary classifier 230 indicates whether the corresponding prediction label is greater than k, ideally, {h_{ϕ}_{ₖ}(ƒ_{θ}(x))}ₖ₌₁^{K-1} should be a list that include a sequence of ones followed by a sequence of zeros. The sequence of ones has a length of k and the sequence of zeros has a length of K−k−1. Hence, {h_{ϕ}_{ₖ}(ƒ_{θ}(x))}ₖ₌₁^{K-1} can be checked using this standard: if there are any zeros that appear in the middle of ones, or any ones that appear in the middle of zeros, then an inconsistency is detected.

A further description will now be given regarding block 360, in accordance with an embodiment of the present invention.

As introduced in block 350, inconsistent binary prediction can be detected if certain kinds of patterns appear. Then, these inconsistent binary predictions can be located as they are flipped, and the predictions are different than their neighboring prediction. Then, the inconsistent prediction is flipped such that the corrected prediction is the same as its neighbors. For example, if K=7 and k=4, then the correct binary predictions should be [1,1,1,1,0,0,0,0], and [1,0,1,1,0,0,0,0] indicates an inconsistent prediction (the second one).

A further description will now be given regarding block 370, in accordance with an embodiment of the present invention.

Once the binary predictions are checked and corrected if any inconsistency is identified, they are then aggregated to obtain the final ordinal prediction as follows:

y_{i,pred}=Σₖ₌₁^{K-1}h_{ϕ}_{ₖ}(ƒ_{θ}(x))

That is, the final prediction is the count of predictions that indicates the label is greater than its current indicator k.

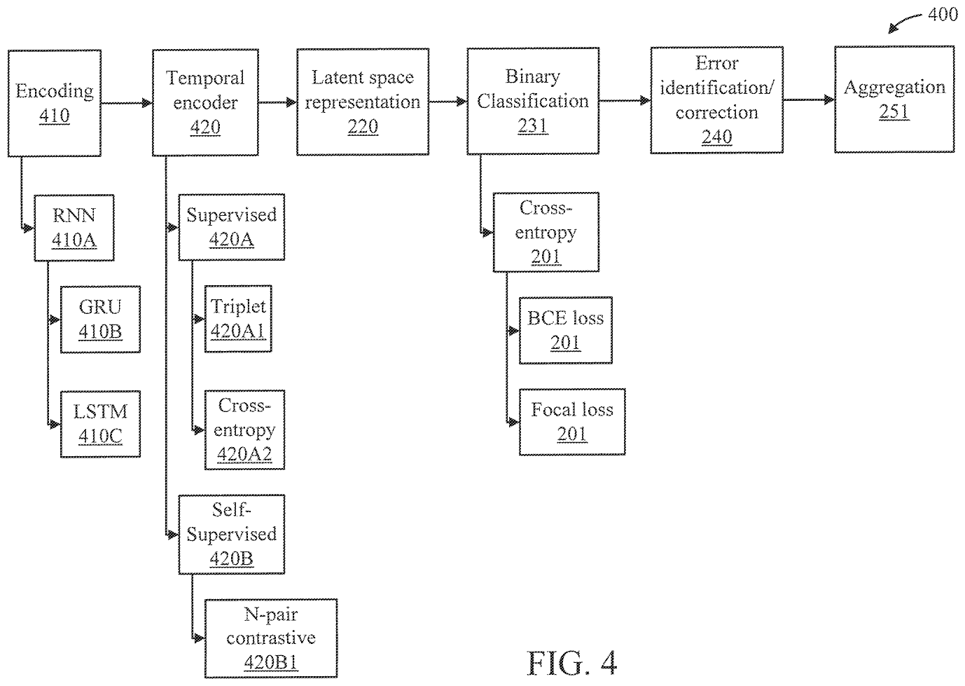

FIG. 4 is a block diagram showing an exemplary processing flow 400 with alternatives, in accordance with an embodiment of the present invention.

At block 410, perform time series encoding. The encoding can involve any of: a Recurrent Neural Network (RNN) 410A; a Gated Recurrent Network (GRU) 410B; and/or a Long Short-Term Memory 410C.

At block 420, perform encoder optimization. The optimization can involve any of: supervised loss 420A; supervised triplet loss 420A1; supervised cross-entropy loss 420A2; self-supervised loss 420B; and self-supervised N-pair contrastive loss 420B1.

At block 430, perform semi-supervised learning to obtain representations.

At block 440, perform binary classification. The classification can involve any of: cross-entropy loss 440A; Binary Cross-Entropy (BCE) loss 440B; and focal loss 440C.

At block 450, perform error identification/correction.

At block 460, perform a binary prediction aggregation.

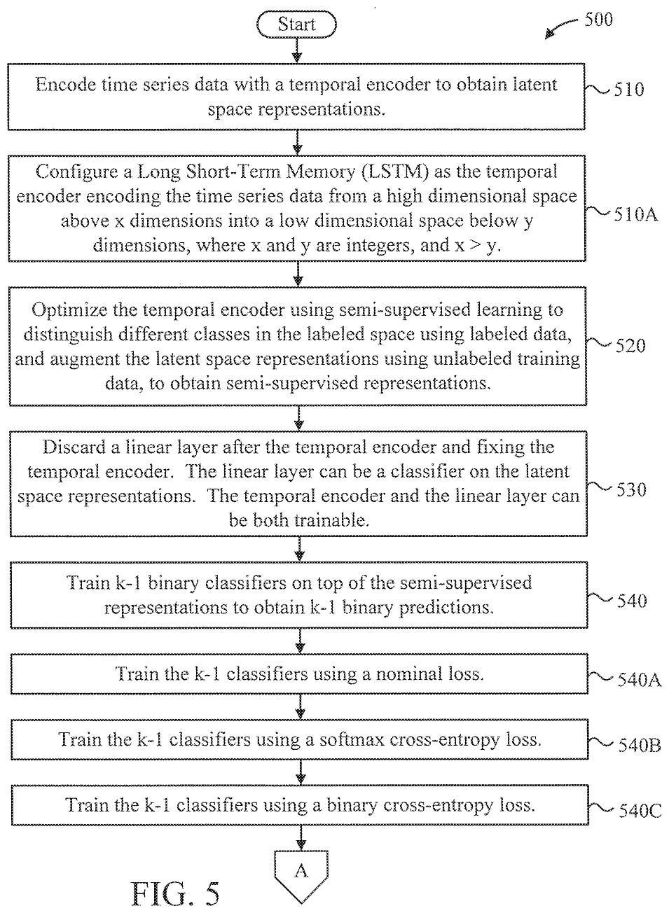

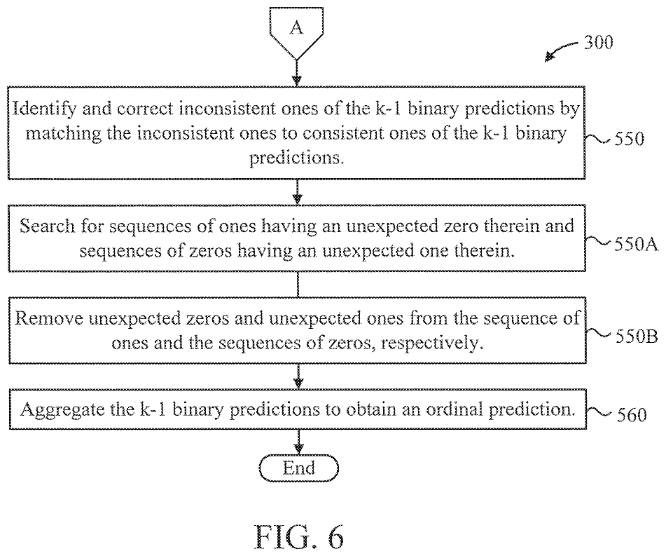

FIG. 5-6 are flow diagrams showing another exemplary method 500 for ordinal classification, in accordance with an embodiment of the present invention. Method 500 provides additional details over higher level method 300.

At block 510, encode time series data with a temporal encoder to obtain latent space representations.

In an embodiment, block 510 can include block 510A.

At block 510A, configure a Long Short-Term Memory (LSTM) as the temporal encoder encoding the time series data from a high dimensional space above x dimensions into a low dimensional space below y dimensions, where x and y are integers, and x>y.

At block 520, optimize the temporal encoder using semi-supervised learning to distinguish different classes in the labeled space using labeled data, and augment the latent space representations using unlabeled training data, to obtain semi-supervised representations.

At block 530, discard a linear layer after the temporal encoder and fixing the temporal encoder. In an embodiment, the linear layer can be a classifier on the latent space representations. In an embodiment, the temporal encoder and the linear layer can be both trainable.

At block 540, train k-1 binary classifiers on top of the semi-supervised representations to obtain k-1 binary predictions.

In an embodiment, block 540 can include one or more of blocks 540A through 540C.

At block 540A, train the k-1 classifiers using a nominal loss.

At block 540B, train the k-1 classifiers using a softmax cross-entropy loss.

At block 540C, train the k-1 classifiers using a binary cross-entropy loss.

At block 550, identify and correct inconsistent ones of the k-1 binary predictions by matching the inconsistent ones to consistent ones of the k-1 binary predictions.

In an embodiment, block 550 can include one or more of blocks 550A and 550B.

At block 550A, search for sequences of ones having an unexpected zero therein and sequences of zeros having an unexpected one therein.

At block 550B, remove unexpected zeros and unexpected ones from the sequence of ones and the sequences of zeros, respectively.

At block 560, aggregate the k-1 binary predictions to obtain an ordinal prediction.

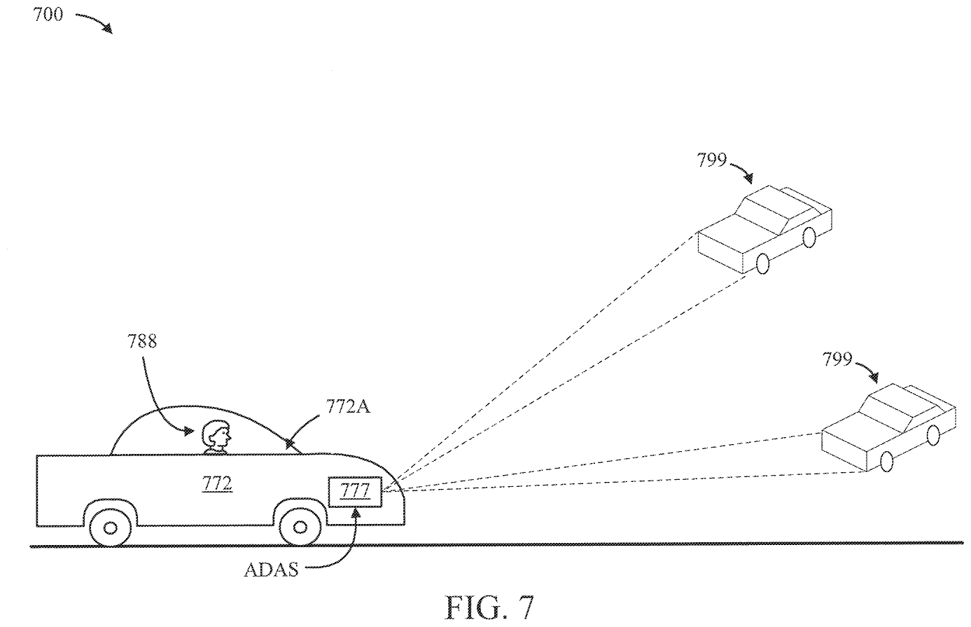

FIG. 7 is a block diagram showing an exemplary environment 700 to which the present invention can be applied, in accordance with an embodiment of the present invention.

In the environment 700, a user 788 is located in a scene with multiple objects 799, each having their own locations and trajectories. The user 788 is operating a vehicle 772 (e.g., a car, a truck, a motorcycle, etc.) having an ADAS 777.

The ADAS 777 receives an ordinal prediction.

Responsive to the ordinal prediction, a vehicle controlling decision is made. To that end, the ADAS 777 can control, as an action corresponding to a decision, for example, but not limited to, steering, braking, and accelerating systems.

Thus, in an ADAS situation, steering, accelerating/braking, friction (or lack of friction), yaw rate, lighting (hazards, high beam flashing, etc.), tire pressure, turn signaling, and more can all be efficiently exploited in an optimized decision in accordance with the present invention.

The system of the present invention (e.g., system 777) may interface with the user through one or more systems of the vehicle 772 that the user is operating. For example, the system of the present invention can provide the user information through a system 772A (e.g., a display system, a speaker system, and/or some other system) of the vehicle 772. Moreover, the system of the present invention (e.g., system 777) may interface with the vehicle 772 itself (e.g., through one or more systems of the vehicle 772 including, but not limited to, a steering system, a braking system, an acceleration system, a steering system, a lighting (turn signals, headlamps) system, etc.) in order to control the vehicle and cause the vehicle 772 to perform one or more actions. In this way, the user or the vehicle 772 itself can navigate around these objects 799 to avoid potential collisions there between. The providing of information and/or the controlling of the vehicle can be considered actions that are determined in accordance with embodiments of the present invention.

While described with respect to an ADAS, the present invention can be applied to a myriad of applications involving, e.g., a trajectory. For example, navigation involving automated agents, robots, assistive technologies for blind people, and/or so forth can be exploited by embodiments of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B).

As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for ordinal prediction of multiple objects, each having their own locations and trajectories, comprising:
encoding time series data with a temporal encoder to obtain latent space representations;
optimizing the temporal encoder using semi-supervised learning to distinguish different classes in the labeled space using labeled data, and augment the latent space representations using unlabeled training data, to obtain semi-supervised representations;
training k-1 binary classifiers on top of the semi-supervised representations to obtain k-1 binary predictions;
identifying and correcting inconsistent ones of the k-1 binary predictions by matching the inconsistent ones to consistent ones of the k-1 binary predictions;
aggregating the k-1 binary predictions to obtain an ordinal prediction of multiple objects, each having their own locations and trajectories; and
navigate around the objects to avoid potential collisions there between.

2. The computer-implemented method of claim 1, wherein the temporal encoder comprises a Long Short-Term Memory (LSTM) encoding the time series data from a high dimensional space above x dimensions into a low dimensional space below y dimensions, where x and y are integers, and x>y.

3. The computer-implemented method of claim 1, further comprising discarding a linear layer after the temporal encoder and fixing the temporal encoder, wherein the linear layer is a classifier on the latent space representations.

4. The computer-implemented method of claim 1, wherein the temporal encoder and the linear layer are both trainable.

5. The computer-implemented method of claim 1, further comprising training the k-1 classifiers using a nominal loss.

6. The computer-implemented method of claim 1, wherein the nominal loss is selected from the group consisting of a softmax cross-entropy loss and a binary cross-entropy loss.

7. The computer-implemented method of claim 1, wherein said identifying step searches for sequences of ones having an unexpected zero therein and sequences of zeros having an unexpected one therein.

8. The computer-implemented method of claim 7, wherein said correcting step removes unexpected zeros and unexpected ones from the sequence of ones and the sequences of zeros, respectively.

9. The computer-implementing method of claim 1, further comprising automatically controlling a vehicle system for collision avoidance responsive to the ordinal prediction predicting an impending collision.

10. A computer program product for ordinal prediction of multiple objects, each having their own locations and trajectories, the computer program product comprising a non-transitory computer readable storage medium having program instructions embodied therewith, the program instructions executable by a computer to cause the computer to perform a method comprising:
encoding, by a hardware processor of the computer, time series data with a temporal encoder to obtain latent space representations;
optimizing, by the hardware processor, the temporal encoder using semi-supervised learning to distinguish different classes in the labeled space using labeled data, and augment the latent space representations using unlabeled training data, to obtain semi-supervised representations;
training, by the hardware processor, k-1 binary classifiers on top of the semi-supervised representations to obtain k-1 binary predictions;
identifying and correcting, by the hardware processor, inconsistent ones of the k-1 binary predictions by matching the inconsistent ones to consistent ones of the k-1 binary predictions;
aggregating, by the hardware processor, the k-1 binary predictions to obtain an ordinal prediction of multiple objects, each having their own locations and trajectories; and
navigating around the objects to avoid potential collisions there between.

11. The computer program product of claim 10, wherein the temporal encoder comprises a Long Short-Term Memory (LSTM) encoding the time series data from a high dimensional space above x dimensions into a low dimensional space below y dimensions, where x and y are integers, and x>y.

12. The computer program product of claim 10, wherein the method further comprises discarding a linear layer after the temporal encoder and fixing the temporal encoder, the linear layer is a classifier on the latent space representations.

13. The computer program product of claim 10, wherein the temporal encoder and the linear layer are both trainable.

14. The computer program product of claim 10, wherein the method further comprises training the k-1 classifiers using a nominal loss.

15. The computer program product of claim 10, wherein the nominal loss is selected from the group consisting of a softmax cross-entropy loss and a binary cross-entropy loss.

16. The computer program product of claim 10, wherein said identifying step searches for sequences of ones having an unexpected zero therein and sequences of zeros having an unexpected one therein.

17. The computer program product of claim 16, wherein said correcting step removes unexpected zeros and unexpected ones from the sequence of ones and the sequences of zeros, respectively.

18. The computer program product of claim 10, wherein the method further comprises automatically controlling a vehicle system for collision avoidance responsive to the ordinal prediction predicting an impending collision.

19. A computer processing system for ordinal prediction of multiple objects, each having their own locations and trajectories, comprising:
a memory device for storing program code; and
a processor device, operatively coupled to the memory device, for running the program code to:
encode time series data with a temporal encoder to obtain latent space representations;
optimize the temporal encoder using semi-supervised learning to distinguish different classes in the labeled space using labeled data, and augment the latent space representations using unlabeled training data, to obtain semi-supervised representations;
train k-1 binary classifiers on top of the semi-supervised representations to obtain k-1 binary predictions;
identify and correct inconsistent ones of the k-1 binary predictions by matching the inconsistent ones to consistent ones of the k-1 binary predictions; and
aggregate the k-1 binary predictions to obtain an ordinal prediction of multiple objects, each having their own locations and trajectories; and
navigate around the objects to avoid potential collisions there between.

20. The computer processing system of claim 19, wherein the temporal encoder comprises a Long Short-Term Memory (LSTM) encoding the time series data from a high dimensional space above x dimensions into a low dimensional space below y dimensions, where x and y are integers, and x>y.
